(19) United States
(12) Patent Application Publication
(10) Pub. No.: US 2011/0022571 A1
(43) Pub. Date: Jan. 27, 2011

(54) METHOD OF MANAGING WEBSITE COMPONENTS OF A BROWSER

(76) Inventor: Kevin Howard Snyder, Charlotte, NC (US)

Correspondence Address: IPxLAW Group LLP, 95 South Market Street, Suite 570, San Jose, CA, 95113, US

(21) Appl. No.: 12/509,288

(22) Filed: Jul. 24, 2009

(51) Int. Cl. G06F 17/30; G06F 9/445

(52) U.S. Cl. 707/692; 717/174; 707/E17.009; 707/E17.005

(57) ABSTRACT

A method of uninstalling all data and objects relating to a Website is disclosed. The user, upon visiting a Website, registers the site with the uninstall software according to a defined registration event. The registration process creates a Meta URL, to which all data and objects relating to the visited Website are associated. The data and objects include URLs, HTML documents, bookmarks or favorites, temporary browser objects such as embedded multimedia, browser cookies, browser history, and browser plug-ins and extensions. A configuration file, local or remote, or a user interface determines which items are removable. Multiple browsers can share the association between the data and objects relating to a Website and the Meta URL and the user can remove a browser from the shared association.

### CROSS-REFERENCE TO RELATED APPLICATIONS

1. Field of the Invention

The present invention relates to a removal or uninstall process for software. More particularly, the present invention relates to a single removal/uninstall process of all local Web browser objects and data associated with and created by connecting to an existing Web Site.

2. Description of the Related Art

A Website, as used herein, is a collection of related Web page, images, videos, embedded multimedia or other digital assets that are addressed with a common (initiating) domain name or IP address in an Internet Protocol-based network. A Web page is a document, usually comprising plain text and Hypertext Markup Language (HTML) formatting instructions, and anchors. The pages of a Website are accessible from a Uniform Resource Locator (URL), which typically points to a page of the site. Website designers usually organize the Web pages of the site into a hierarchy, though navigation within the site need not conform to the hierarchy.

When a user visits a Website, his browser may install a number of objects and data related to that Website. At some point, a user may wish to remove these objects and data from his computer system. However, because Website related browser objects and data (hereinafter referred to as “Website components”) are unlike regular software applications, which after being installed can be uninstalled, no holistic mechanism or process exists for removing safely and completely all of these items.

Because direct removal is not possible, the user must employ certain tools, such as browser clean up tools, to attempt to clean a Website from a computer system. These browser clean-up tools are simply a collection of distinct, separate, and uncoordinated tasks, which perform removal on a file-by-file or object-by-object or tabular basis (for browsers that use tabs). These tools do not track any relationships between Websites and any of the browser objects or data that are associated with the Websites. With browser clean-up tools, the user has no assurance that he can remove, completely and safely, all of the browser objects and data related to a Website.

A need thus exists for an improved process that allows a user to uninstall safely and completely a Website and its related objects and data.

### BRIEF SUMMARY OF THE INVENTION

The present invention provides a Website Uninstaller, a program or Browser functional addition, such as a plug-in or extension, or any combination thereof, by which a user can remove all Website components from a computer system. The present invention performs this process by registering Websites as single entities, and storing and maintaining a relationship between all associated browser objects and the Websites.

In accordance with the present invention, the Website Uninstaller is configurable to define which object types are recorded in a Website entry record as well as which events trigger the registration process. Each browser can have it is own uninstaller but all the uninstallers can share the same rules and associations.

Further in accordance with the present invention, the Website Uninstaller can remove all browser objects such as cookies, temporary files, browser cache objects, bookmarks, favorites, browser plug-in, browser extensions, and browser history related to a Website from the computer system by means of a single process.

Moreover, browser object relationships are shareable between multiple browsers, thereby permitting the removal of all entities and browser objects related to a Website regardless of the particular browser used to visit the Website.

One embodiment of the present invention provides a method of managing in a computer system one or more browser objects and data associated with a Website identified by a particular URL. The method includes the steps of (i) visiting a Website by entering an URL into a browser, (ii) defining and registering a current Meta URL for the browser based on the URL of the visited Website, and (iii) while in the visited Website, permitting one or more browser objects or data related to the visited Website to be installed in the computer system and associating the objects or data with the current Meta URL, and upon an occurrence of an uninstall request, cleaning all entities and browser objects related to a registered Website from the computer system by removing objects and data associated with a current Meta URL for the registered Website.

### BRIEF DESCRIPTION OF THE DRAWINGS

These and other features, aspects and advantages of the present invention will become better understood with regard to the following description, appended claims, and accompanying drawings wherein:

FIG. 1A shows a system setting in which a Website Uninstaller operates;

FIG. 1B shows a representative basic computing system;

FIGS. 2A-2F show flow charts of the Website Uninstaller Operations;

FIG. 3 shows a sample XML file, which defines the associations between Website components and two distinct Meta URLs;

FIG. 4 shows a sample master registration file;

FIG. 5A shows a descriptive configuration file; and

FIG. 5B shows a sample configuration file.

### DETAILED DESCRIPTION OF THE INVENTION

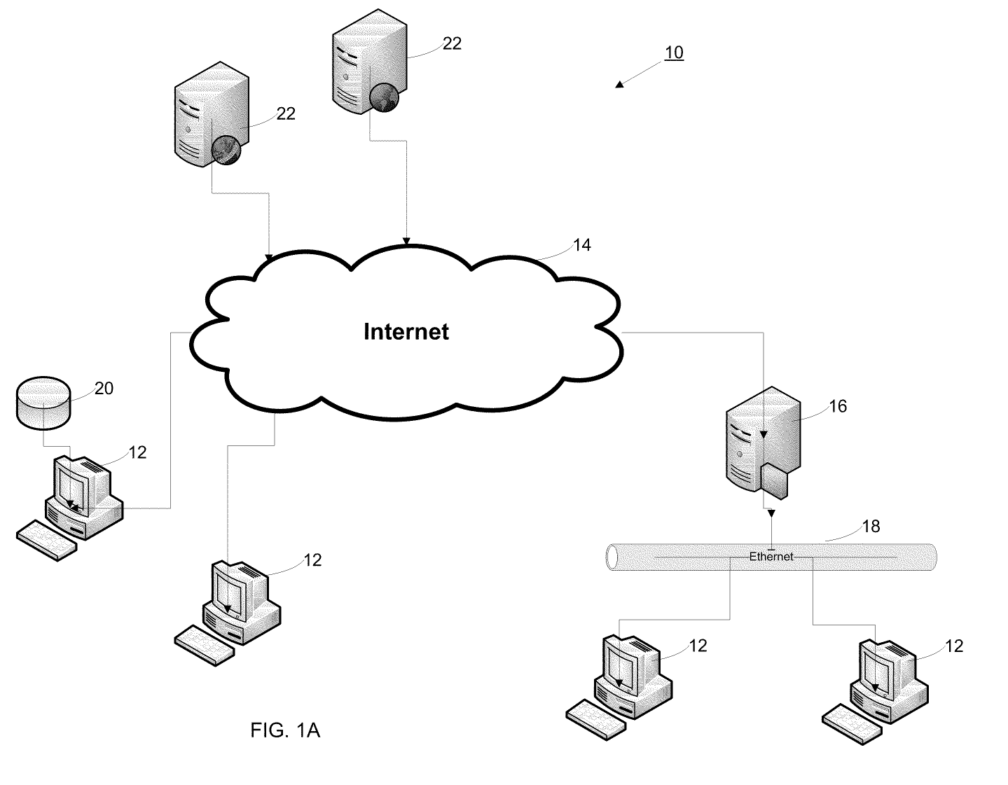

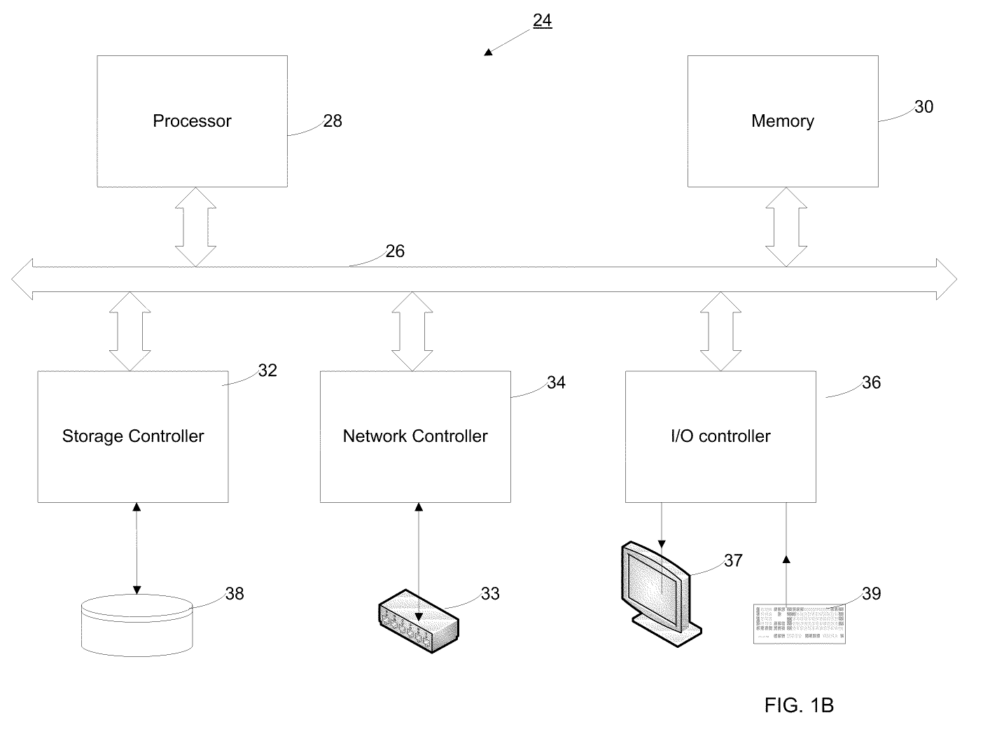

FIG. 1A shows a system setting 10 in which the Website Uninstaller operates. The setting includes a plurality of client computer systems 12 each connected to the Internet or an Intranet 14 either directly or through a proxy server 16 via a local area network 18. A browser runs on each of the client computer systems. In one version, a client computer system 12 connects to a database 20 that stores configuration information for the Website Uninstaller. The client computer systems 12 access, via the Internet or Intranet 14 Website servers 22, which provide Web pages to the browsers in the client computer systems. The Website Uninstaller software can be implemented as a separate software process, a Browser extension or plug-in, or a built-in function in the Browser or any combination of these.

FIG. 1B shows a representative basic computing system 24. Connected to a main internal bus 26 are the processor 28, the memory 30, a storage controller 32, a network controller 34 and an I/O controller 36. The processor 28 executes programs loaded in the memory 30. The storage controller 32 maintains a connection to permanent storage 38, such as a hard disk, which stores the programs that are loaded for execution into the memory 30. The network controller 34 manages a connection to a hub or router 33, and the I/O controller 36 manages, among other things, the monitor 37 and keyboard/mouse 39.

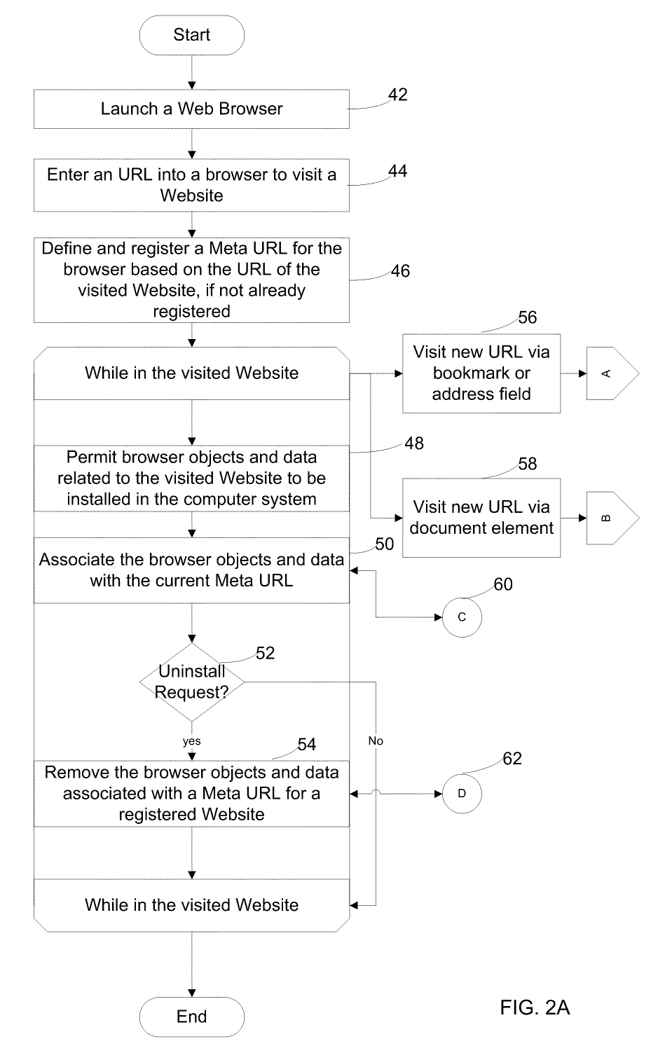

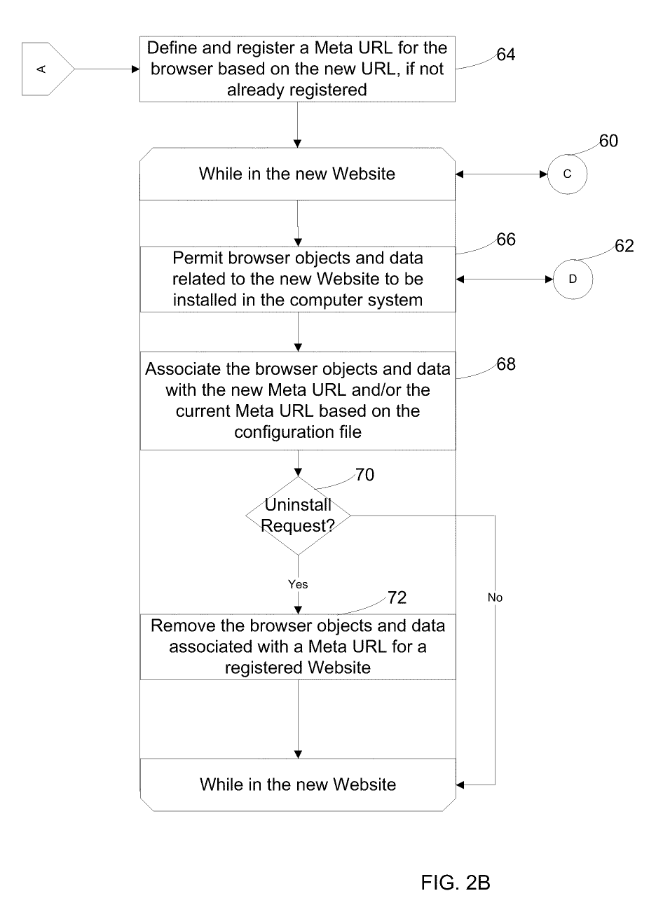

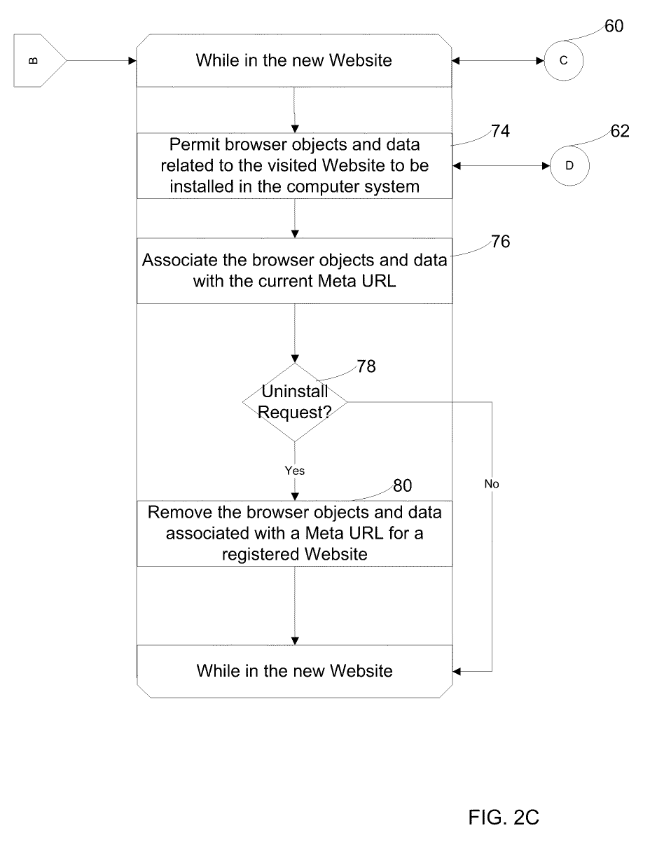

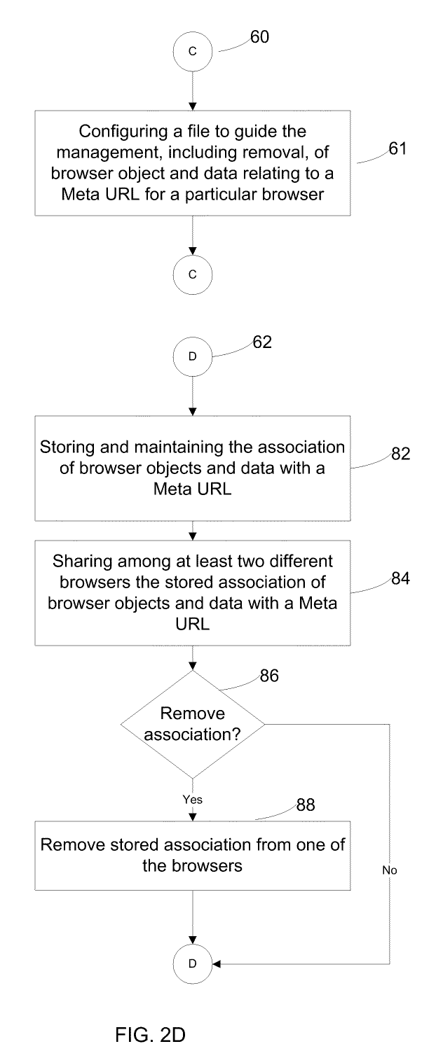

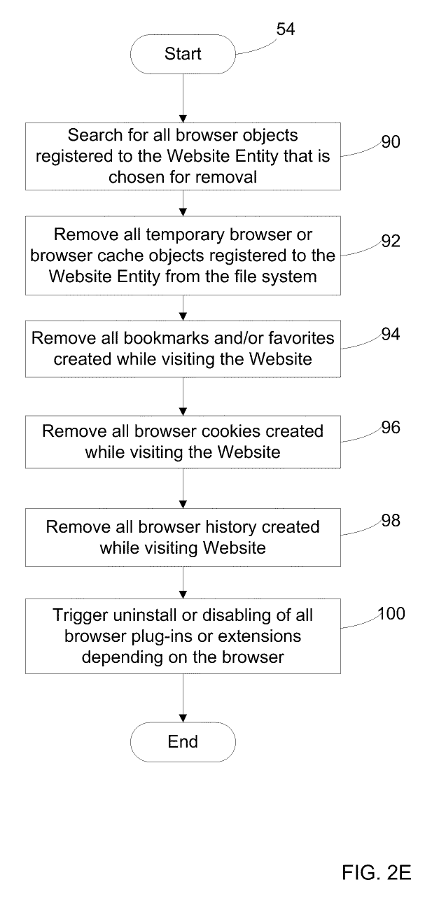

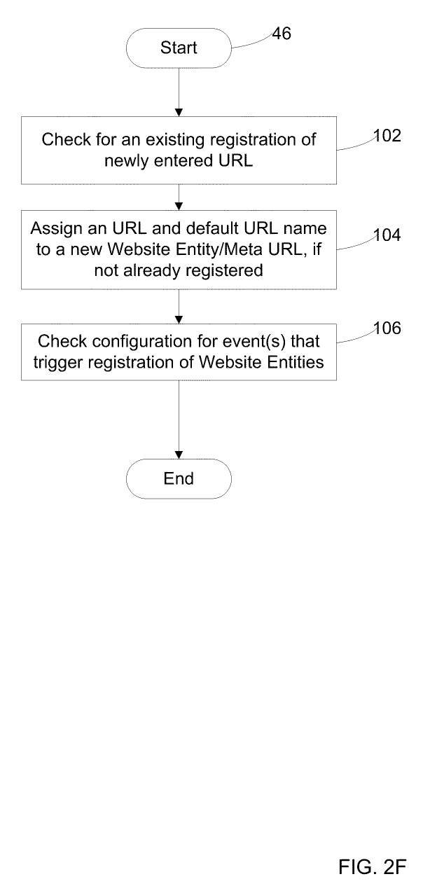

Referring to FIG. 2A, in order to display a Web document, the user employs the following steps. In step 42, the user launches a Web Browser. The Browser type is typically Microsoft Internet Explorer, Firefox, Mozilla, Chrome, but is not limited to these. In step 44, the user enters an URL into the browser to visit a Website. In step 46, the software defines and registers a Meta URL for the browser based on the URL for the visited Website, if the Website is not already registered. Registration creates a Website Entity, which is an entry that permits associations between a Meta URL and browser objects and data encountered while in the Website as defined above. For example, a Website Entity consists of the Meta URL, the associated display name for the Meta URL, and all objects registered to the Meta URL. Registered Entities have shared Metadata consisting of the initiating URL (also referred to as “Meta URL”) and a Website Name. A Website for which a Website Entity exists is also referred to as “registered Website.” Registration and all associations are stored in a local file (such as XML), in a database (local or remote), in a remote file (accessible via a Network Connection), in the Windows Registry, or in some storage facility readily accessible by the Website Uninstaller.

While in the visited Website, with the browser displaying the HTML document, the user, in step 48, permits browser objects and data related to the visited Website to be installed in the computer system. In step 50, the software associates these browser objects and data with the current Meta URL. In addition, while in the visited Website, in step 52, the user can make an uninstall request to remove browser objects and data associated with a Meta URL for a registered Website. If so, the software removes, in step 54, the browser objects and data associated with a Meta URL for the registered Website from the computer system. The registered Website may be the visited Website or another Website.

Registering the URL as a Meta URL

The user, in step 46, registers the URL as a Meta URL by designating and storing it as such. If the software has not registered the current URL, then the user can create a new Meta URL entry in the Website Uninstaller for that URL. The current URL defines a Website, regardless of the presence of embedded frames or similar features.

A Meta URL by default consists of at least the initiating URL (the first URL accessed upon starting the browser). A Website entity comprises the Meta URL, name, and associated objects. There can be multiple instances of each element except for the Name and Originating Request elements. A Meta URL has the following fields.

```
  <URL>
  <Name> </Name>
  <OriginatingRequest> </OriginatingRequest>
  <Bookmark> </Bookmark>
  <Cookie> </Cookie>
  <CacheObject> </CacheObject>
  <HistoryObject> </HistoryObject>
  <ChildPlugin> </ChildPlugin>
</URL>
```

In the structure above, the ChildPlugin includes both Browser Extensions and Browser Plugins. The CacheObject includes Temporary Objects. It is intended that these elements be shared across different Browser types, even though terminology might be different among the different browsers.

Once an initial URL is registered as a Meta URL, all following navigations (by default) are associated with the Meta URL, unless a new URL is entered in the Address field, a bookmark or favorite is used to reach a different URL, or the Browser Home page is selected. A user can manually register any URL as a Meta URL.

The registration tasks for registering a Meta URL include: checking, in step 102 of FIG. 2F, for an existing registration of a newly entered URL; assigning, in step 104, an URL and default URL name to a new Website Entity/Meta URL if not already registered; and checking, in step 106, the Website Uninstaller configuration for the event that triggers registration of Website Entities. Preferably, the software saves the registration in a local or remote database, a local or remote XML file or, a remote location supporting HTTP connections. A registration can occur before or after the following Internet Explorer events, or similar events in other browsers, OnBeforeNavigate, OnNavigateComplete, OnDocumentComplete, OnDownloadBegin, OnDownloadComplete, OnNavigateError, or OnQuit.

The OnBeforeNavigate event is an event that triggers registration before a navigation to a new URL. The OnNavigateComplete event triggers registration after navigation to a new URL is complete. The OnDocumentComplete event triggers registration when a document has reached the ReadyState_Complete state. The OnNavigateError event triggers registration when navigation to a new URL fails. The OnQuit event triggers registration when the browser (Internet Explorer) quits.

The greater the number of events that trigger a registration, the better able the uninstaller is to perform a more complete cleanup process. For example, with the OnNavigateError registration event, the uninstaller is able to clean up objects installed when navigation to a new URL fails.

Associating New Objects or Data With a Meta URL

The software associates, in step 50, new objects or data with a Meta URL. The new objects or data include new URLs, new HTML documents, new browser temporary or cache objects, new browser cookies, new browser history objects, new bookmarks or favorites, embedded objects such as multimedia, and newly installed browser plug-ins or extensions (through the current page). Each of these objects can arise from the current Website or any other browser objects registered to the URL. These new objects are associated with the Meta URL entry previously registered.

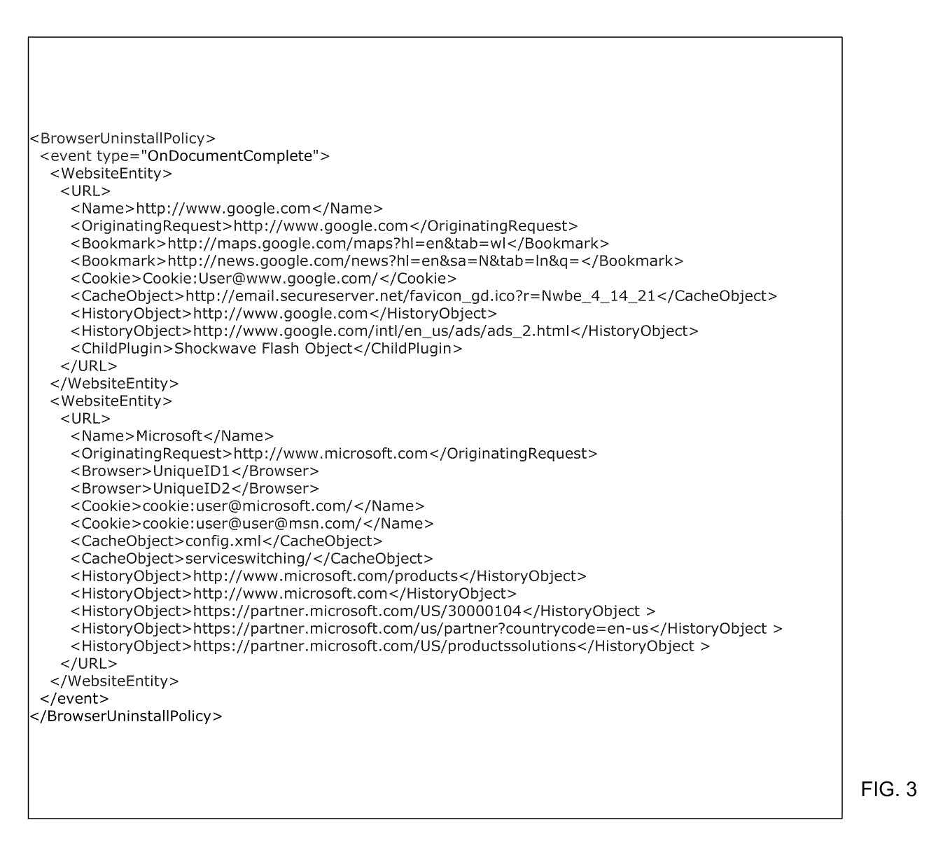

The association of new objects is stored in some predefined format such as XML and the selection of browser objects is configurable. FIG. 3 shows one way of storing the associations.

Uninstalling a Registered Website

The user can request, in step 52, that the software uninstall all of the browser objects registered for the Meta URL of a previously registered Website. By default, the uninstall process occurs against the current Website Entity, though the user can choose to uninstall a different Website Entity. The functions that occur in these steps depend on the Uninstaller configuration.

As shown in FIG. 2E, the Uninstall tasks include searching, in step 90, for all browser objects registered to the Website Entity that is chosen for removal; removal, in step 92, of all temporary browser or browser cache objects registered to the Website Entity from the file system; removal, in step 94, of all bookmarks and/or favorites created while visiting the Website; removal, in step 96, of all browser cookies created while visiting the Website; removal, in step 98 of all browser history created while visiting the Website; and triggering the uninstall or disabling, in step 100, depending on the browser, of all browser plug-ins or extensions.

Select a New URL via Browser Component

In step 56, the user can, at any time, select a new URL by using a bookmark/favorite, address field, or by navigating via the Home button. The system then navigates to the new URL, as shown in FIG. 2B. The new URL is defined and registered, in step 64, as a Meta URL for the browser based on the new URL, if it is not already registered. While in the new Website, the software permits, in step 66, browser objects and data related to the new Website to be installed in the computer system. The software again associates, in step 68, the browser objects and data with the new Meta URL and/or the current Meta URL based on the configuration file. In step 70, the user can make an uninstall request to remove, in step 72, the browser objects and data associated with an existing Meta URL.

The software considers movement to a new manually-entered URL as movement to a new Website. In this case, when the software encounters a new browser object or data, the software registers it to the new Website, unless the configuration indicates that the new browser objects and data should be registered to both the old and the new Meta URLs.

Navigate to a New URL

At any time, the user can navigate, in step 58, to a new URL through a document element such as an HTML link. The Web browser continues to operate normally, permitting, in step 74 of FIG. 2C, objects and data related to the new URL to be installed in the computer system. A new Website entity is not automatically registered. The current Meta URL entry does not change, and any new page and associated objects are associated, in step 76, with the current Website entity. If the user wants to register a new Website entity, he must do so manually. In addition, the user can again make, in step 78, an uninstall request to remove in step 80, the browser objects and data associated with an existing Meta URL.

The software considers that repeated use of the Back or Forward button in the browser, to move to a point before that at which the Meta URL was established, is the same as visiting a new Website, which may need to be registered, unless it is already registered.

Sharing Associations and Objects Among Browsers

In step 62 in FIG. 2A, 2B, or 2C, the software stores and maintains, in step 82, the association of browser objects and data with a Meta URL. This permits sharing, in step 84, among two different browsers of the stored associations. The user can decide, in step 86, to remove, in step 88, one of the stored associations from a browser.

One embodiment of the present invention permits a user to select a particular browser from which to remove objects. In this case, the user interface must be capable of associating a well-known browser name with a unique browser ID. However, this is not necessary if the Uninstall process is implemented within the browser itself, because the software can assume that objects are to be removed from the current browser instance. In any event, the storage facility must be updated to remove the browser unique ID.

Regarding whether multiple browsers share Meta URLs and associations, the software makes a distinction between multiple browsers relying on the same Website registrations and multiple browsers running simultaneously.

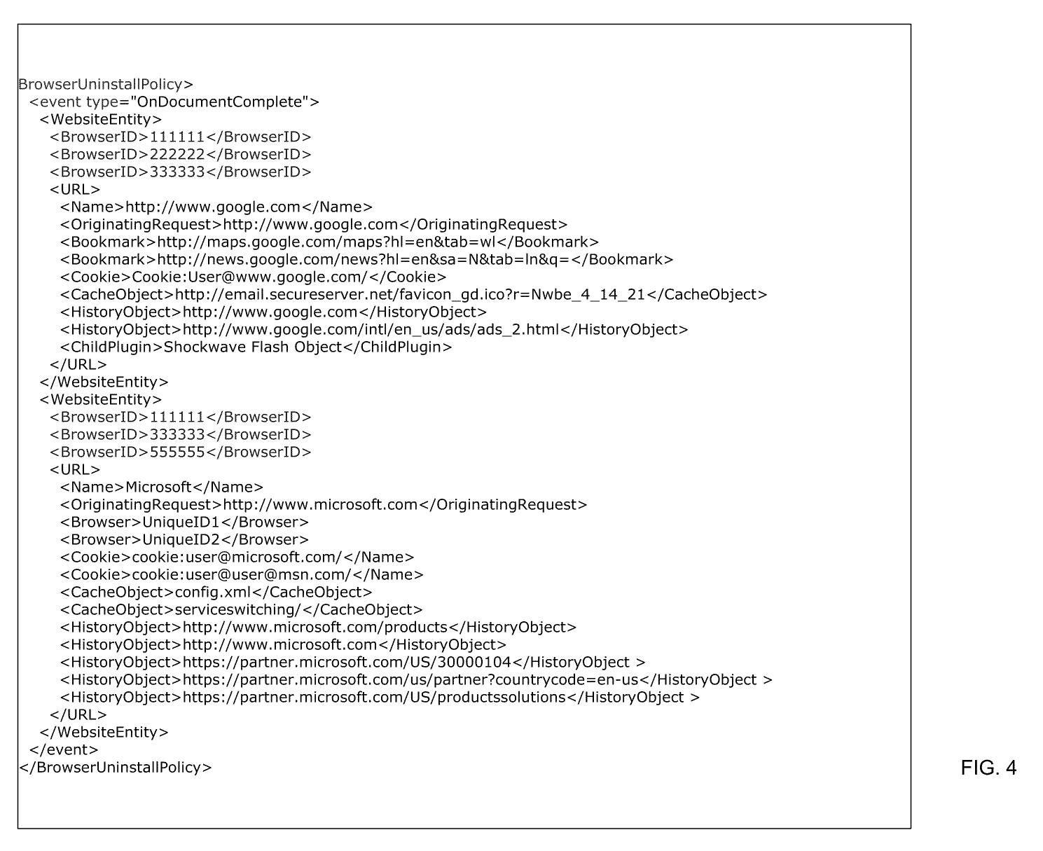

If multiple browsers run simultaneously, each browser has its own copy of the registration file or database entry. When the browser session is ended, the software synchronizes the registration file with a master registration file using standard data synchronization rules. This keeps changes by the current browser session unexposed until the browser session has ended. FIG. 4 shows a sample master registration file. The Master Registration File may be stored locally, if, for example, the browsers are supported on a single machine. The Master Registration File may also be stored remotely, if, for example, an organization of users is expected to chare the same Website Entities.

If multiple browsers share the same Website registrations, but not at the same time, the software maps browser events and some object definitions between browser types. The particular events that are mapped depend on the browser type, because in some cases a certain browser event may be recognized for one browser type but not for another browser type. In addition, the name of the same event in one browser may be different for another browser. For example, the OnQuit event in Internet Explorer may map to the OnExit event on a different browser. Thus, a logically accurate mapping of events between browsers must be defined.

If multiple Websites share browser objects, the software removes objects when requested, regardless of whether other Websites use them. A request to remove a non-existent object causes the software to register the object as deleted and dissociated with the Website, but takes no other action.

If only one browser is registered with the Website Uninstaller, then after removing the Website objects, the Website entry is removed from the storage facility that holds it. If multiple browsers are registered, the browser reference in the Website Entity is removed, with the result that the browser that is removed is no longer available to the Uninstall process for this specific Website Entity. Thus, the Uninstall process still operates for the browser except that the browser no longer recognizes the Website Entity as available to be uninstalled. In the storage facility, each browser must be uniquely identified so that the browser objects are removed from the correct browser.

If no objects exist, the Uninstall process does not run except to clean up or remove the storage facility entries.

If multiple Websites share an object, the software will still remove it. The removal does not harm the operation of a Website, which when re-visited, will simply reinstall the needed object.

Changing A Meta URL Display Name

A user changes the Meta URL display name when the user desires a more user-friendly reference to the Meta URL (the display name functions as an alias to the Meta URL). FIG. 3 shows an example where the originating request is http://www.microsoft.com and the Website Entity is named Microsoft.

Changing a Meta URL

A user changes the Meta URL when the user wants to define the Meta URL based on a more popular location, that is, to expand the coverage of a Meta URL. For example, if a Website is initially registered as http://finance.yahoo.com/marketupdate/overview, the user may wish to change the Meta URL to http://finance.yahoo.com.

Configuring the Website Uninstaller

The user configures, in step 60, the Website Uninstaller by entering and storing, in step 61, specific information. Specifically, in configuring the Website Uninstaller, the user specifies a number of parameters, which at least include (i) the event or events that trigger the registration of browser objects for a Website Entity; (ii) the types of objects to associate with a Website, (iii) whether multiple browsers share Meta URLs and associations; (iv) whether the user wants to customize the originating URL; (v) whether the user wants to change the display name of the Meta URL; (v) whether to activate or deactivate the registration of new Websites and new Website objects; and (vi) whether and how a Website should be ignored.

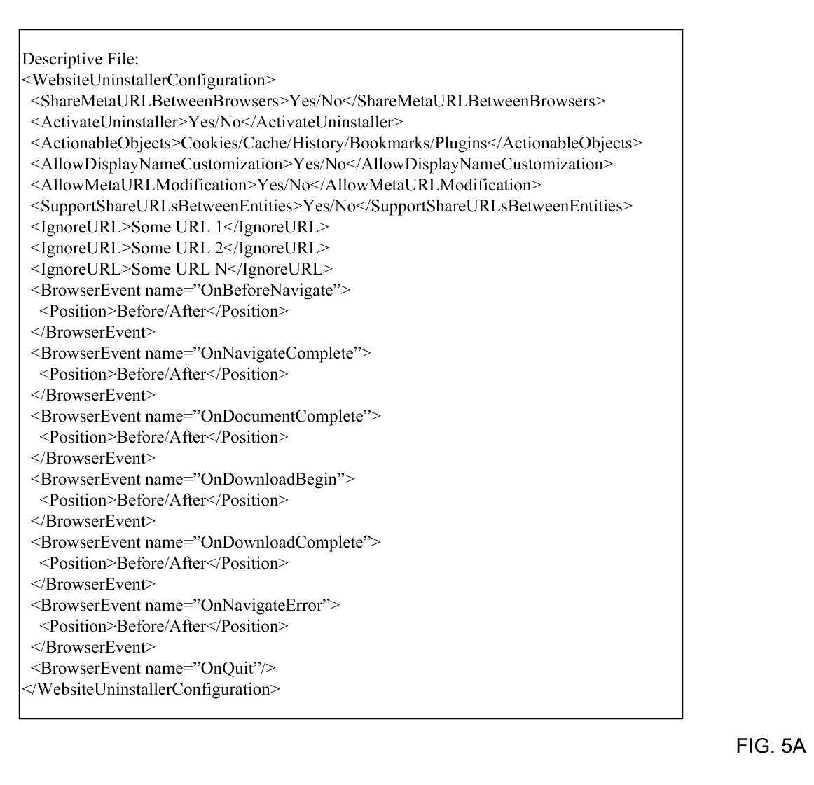

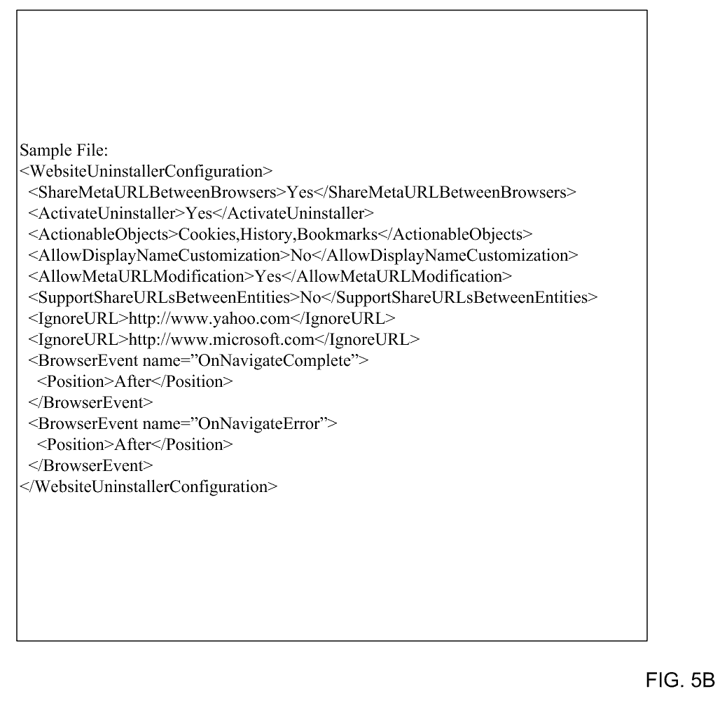

FIG. 5A shows a descriptive configuration record. This record shows each configuration parameter option between its respective HTML tags. For example, the configuration declares that the objects on which the Uninstaller operates are Cookies, Cache, History, Bookmarks, and Plugins, as these items are placed between the ActionalObjects tags. FIG. 5B shows a sample configuration record, i.e., one that uses some of the parameters in a typical circumstance.

Regarding the triggering events, not all events that can trigger the running of the Website Uninstaller make sense in every case. As defined above, an event is used to define when a browser object or data, such as cache, bookmark/favorite, history, plug-in/extension, is recorded as belonging to the Website Entity. Internet Explorer supports the following events:
1. OnBeforeNavigate2/OnBeforeNavigate (OnBeforeNavigate2 is a more recent implementation)
2. OnDocumentComplete
3. OnDownloadBegin
4. OnDownloadComplete
5. OnNavigateComplete2/OnNavigateComplete
6. OnNavigateError
7. OnNewWindow2
8. OnQuit
   Because some events are dependent on others, checking on the originating event may eliminate the need to check on the final event. For instance, checking on OnDownloadBegin eliminates the need to check on OnDownloadComplete. Similarly, OnBeforeNavigate2 may eliminate having to check for OnNavigateComplete2. In addition, the user may directly eliminate the need to check on OnDownloadComplete using a configuration parameter.

Mouse events, such as clicking the mouse, may also be useful to trigger the recording of browser object or data.

Document Object Model (DOM) Events may be use for triggering. Typical DOM events are:

1. load

2. unload

3. abort

4. error

5. select

6. change

7. submit

8. reset

9. focus

10. blur

11. resize

12. scroll

Some or all of these events may be used.

In the case of ignoring a Website, the user has a choice as to whether to exclude the ignored site from the Website Uninstall software, or to disable triggering in the registration task.

A user interface, a configuration file, or a remote configuration mechanism can configure the Website Uninstaller.

The default configuration is to remove bookmarks or favorites, temporary browser objects including embedded multimedia, browser cookies, and browser history. Browser plug-ins and extensions are not uninstalled and/or disabled by default. However, the configuration can be set to keep any or all of these objects.

Even though the above discussion described configuration by a user, the Website Uninstaller also may be configured programmatically (with no user intervention). The allowable configurations are the same in either case.

FIG. 3 shows a sample XML file that holds the data that is saved between browser sessions. Note that child URLs (URLs navigated to from the Meta URL, as embodied in Step 13) are considered members of the Meta URL, until or unless they are registered as their own Meta URL in Step 9 (so all objects created by visiting a child URL get registered as belonging to the Meta URL). Upon starting the browser, the initial URL is always considered to be a Meta URL.

Although the present invention has been described in considerable detail with reference to certain preferred versions thereof, other versions are possible. Therefore, the spirit and scope of the appended claims should not be limited to the descriptions of the preferred versions contained herein.

What is claimed is:

1. A method of managing in a client computer system one or more browser objects and data associated with a Website identified by an URL, the method comprising:
visiting a Website residing on a server computer system by entering an URL into a browser running on the client computer system;
defining and registering a current Meta URL for the browser based on the URL of the visited Website; and
while in the visited Website, performing the following steps:
permitting one or more browser objects or data related to the visited Website to be installed in the client computer system and associating said objects or data with the current Meta URL; and
upon an occurrence of an uninstall request, cleaning a registered Website from the client computer system by removing objects and data associated with the current Meta URL for the registered Website.

2. The method of managing browser objects and data as recited in claim 1, wherein a registered Website includes the visited Website.

3. The method of managing browser objects and data as recited in claim 1, wherein removing said objects and data includes:
searching for all browser objects and data registered to the current Meta URL; and
based on the results of the search,
removing any temporary browser or browser cache objects found by the search;
removing any bookmarks and/or favorites found by the search;
removing any browser cookies found by the search;
removing any browser history found by the search; and
triggering the uninstall or disabling of any browser plug-ins or extension found by the search.

4. The method of managing browser objects and data as recited in claim 1, further comprising the step of configuring a file to guide the management, including removal, of said objects and data.

5. The method of managing browser objects and data as recited in claim 4,
wherein the configured file indicates that browser objects and data are to be associated with a new Meta URL and the current Meta URL; and
further comprising the steps of
visiting a new URL via a bookmark or address field;
defining and registering a new Meta URL for the browser based on the new URL; and
while in the Website of the new URL, associating browser object and data with the new Meta URL and the current Meta URL.

6. The method of managing browser objects and data as recited in claim 4, wherein registering a current Meta URL includes:
checking for an existing registration of a newly entered URL;
assigning an URL and default URL name to a new Meta URL, if not already registered; and
checking a configuration file for any events that trigger registration of Website Entities.

7. The method of managing browser objects and data as recited in claim 1,
storing and maintaining the association of the browser objects and data with the Meta URL; and
sharing among at least two different browsers said stored association of said objects and data with the Meta URL.

8. The method of managing browser objects and data as recited in claim 7, further comprising removing from one of the browsers said stored association upon the occurrence of the uninstall request.

9. The method of managing browser objects and data as recited in claim 1, wherein an uninstall request includes a user request to clean a registered Website from the computer system.

10. The method of managing browser objects and data as recited in claim 1, wherein an uninstall request includes a remote request to clean a registered Website from the computer system.

11. The method of managing browser objects and data as recited in claim 1, wherein the step of registering a Meta URL occurs in response to one of a number of pre-defined events.

12. The method of managing browser objects and data as recited in claim 11, wherein said predefined events are taken from a group consisting of: OnBeforeNavigate, OnNavigateComplete, OnDocumentComplete, OnDownloadBegin, OnDownloadComplete, OnNavigateError, or OnQuit.

13. The method of managing browser objects and data as recited in claim 1,
further comprising navigating to a new URL through a document element while in the visited Website; and
wherein any browser objects and data relating to the new URL are associated with the current Meta URL.

14. The method of managing browser objects and data as recited in claim 13, wherein the document element is an HTML link.

15. A program storage device readable by a machine tangibly embodying a program of instructions executable by the machine to perform method steps for managing in a client computer system one or more browser objects and data associated with a Website identified by an URL, said method steps comprising:
visiting a Website residing on a server computer system by entering an URL into a browser running on the client computer system;
defining and registering a current Meta URL for the browser based on the URL of the visited Website; and
while in the visited Website, performing the following steps:
permitting one or more browser objects or data related to the visited Website to be installed in the client computer system and associating said objects or data with the current Meta URL; and
upon an occurrence of an uninstall request, cleaning a registered Website from the client computer system by removing objects and data associated with the current Meta URL for the registered Website.

16. The method of managing browser objects and data as recited in claim 15, wherein removing said objects and data includes:
searching for all browser objects and data registered to the current Meta URL; and
based on the results of the search,
removing any temporary browser or browser cache objects found by the search;
removing any bookmarks and/or favorites found by the search;
removing any browser cookies found by the search;
removing any browser history found by the search; and
triggering the uninstall or disabling of any browser plug-ins or extension found by the search.

17. The method of managing browser objects and data as recited in claim 15, further comprising the step of configuring a file to guide the management, including removal, of said objects and data.

18. The method of managing browser objects and data as recited in claim 17, wherein registering a current Meta URL includes:
checking for an existing registration of a newly entered URL;
assigning an URL and default URL name to a new Meta URL, if not already registered; and
checking a configuration file for any events that trigger registration of Website Entities.

19. The method of managing browser objects and data as recited in claim 15,
storing and maintaining the association of the browser objects and data with the Meta URL; and
sharing among at least two different browsers said stored association of said objects and data with the Meta URL.

20. The method of managing browser objects and data as recited in claim 15, wherein the step of registering a Meta URL occurs in response to one of a number of pre-defined events.

21. The method of managing browser objects and data as recited in claim 20, wherein said predefined events are taken from a group consisting of: OnBeforeNavigate, OnNavigateComplete, OnDocumentComplete, OnDownloadBegin, OnDownloadComplete, OnNavigateError, or OnQuit.

22. A method of managing in a client computer system one or more browser objects and data associated with a Website identified by an URL, the method comprising:
visiting a Website residing on a server computer system by entering an URL into a browser running on the client computer system;
defining and registering a current Meta URL for the browser based on and corresponding to the URL of the visited Website; and
while in the visited Website,
permitting one or more browser objects or data related to the visited Website to be installed in the client computer system, and
associating the installed one or more browser objects or data related to the visited Website with the current Meta URL, so that, upon an uninstall request, a registered Website can be cleaned from the client computer system by removing objects and data associated with the current Meta URL for the registered Website.
